(19) United States
(12) Patent Application Publication
(10) Pub. No.: US 2003/0033251 A1
(43) Pub. Date: Feb. 13, 2003

(54) Secure multi-function cash dispensing system

(76) Inventor: David Sherlock, Culver City, CA (US)

Correspondence Address: CARLSON, GASKEY & OLDS, P.C., 400 WEST MAPLE ROAD, SUITE 350, BIRMINGHAM, MI, 48009, US

(21) Appl. No.: 10/207,325

(22) Filed: Jul. 29, 2002

Related U.S. Application Data
(60) Provisional application No. 60/311,500, filed on Aug. 10, 2001.

(51) Int. Cl. G06F 17/60

(52) U.S. Cl. 705/43

(57) ABSTRACT

A system is provided that allows a user to obtain money both under ATM and POS transactions. In the event of a denial of a transaction, a transaction is ended. At the time the transaction is ended, a screen provides information to the user both of the denial, and of the fact that the user could retry some other type of transaction, or could retry the same type transaction. The invention provides a more secure way of transmitting cash to a user than has been available in the past. Further, the system is better able to communicate with a potentially distracted user in a high stimulus environment such as a casino.

### BACKGROUND OF THE INVENTION

This invention relates to a system which more securely provides cash to a user through several distinct possible types of financial transactions.

For years cash has been available through so called automatic teller machines (“ATM”). In a standard ATM machine a user inserts a bankcard to begin a transaction. The user is then asked to enter an amount which is to be withdrawn, in the case of a withdrawal. This withdrawal request is then transmitting to a financial entity which evaluates the balance of the user to determine whether the amount requested can be provided through an ATM transaction. ATM transactions also typically have limits on the amount which can be withdrawn in any single day. Thus, the requested amount will also be compared to whether the limit for a particular day has already been exceeded, or would be exceeded if the particular transaction were completed. The processing of these requests typically go through a financial entity called a processor. The processor communicates between the ATM receiving the request, and to the particular bank of the cardholder which is making the request.

In some settings, a second type of transaction known as a point of sale (“POS”) transaction is utilized. Generally, a POS transaction has some additional level of security available to it, and will thus often allow the withdrawal of a somewhat higher amount of money. The request is typically transmitted through a second processor to the card issuing bank. The request is compared to the available balance and often to an amount for the particular day. However, since completing POS transaction typically involves interaction with an operator (such as a cashier) the POS daily limits are higher than an ATM daily limit.

In some locations, the function of both an ATM and a POS have been provided in a single machine. In particular, in a casino environment, there have historically been both ATM and POS machines. More recently, there have been the combination of the two machines.

In one prior system, when an ATM transaction is denied since it would exceed the balance or daily limit, the system asks if the user would like to try a second type transaction. In particular, the system asks if the user would like to try a POS transaction upon denial of an ATM transaction. In some instances, due to the higher daily limit, an amount denied from an ATM transaction, might be approved as a POS transaction.

There are deficiencies with regard to the prior system. In particular, in a casino environment, many of the users of the machines are distracted. Thus, when the initial denial is received, some users may simply walk away from the machine. If the machine then moves into the mode of offering a second type transaction, that second type transaction may be offered in an unsecured fashion. Further, a user might like to simply request another ATM transaction in a lower amount in the event that a first requested amount is denied. Thus, simply requesting whether a distinct type transaction would be desirable for a user who has been denied, has some deficiencies.

### SUMMARY OF THE INVENTION

In a disclosed embodiment of this invention, once a first transaction is denied for having exceeded a preset limit, or an insufficient balance, the system immediately ends the transaction. The card user will be asked to reswipe a card, or a new user will be asked to swipe a card before any transaction can occur. Moreover, when the denial is first announced, it will be announced in combination with instructions to swipe a card should any of the original type transactions be desired. Thus, there is no danger of an unsecured transaction occurring. The original transaction has ended. Moreover, if the new user would like to request a second chance at the first type transaction (i.e., request a lower amount for the ATM request), that option is also readily available.

While the specific provision of the particular types of transactions may appear to be something the user could otherwise readily obtain, it must be remembered that in the high stimulus environment of a casino, it is often true that users are distracted quickly. Providing both the denial and the option screen simultaneously is thus beneficial. Moreover, ending the transaction at the denial is also a very beneficial step.

These and other features of the present invention can be best understood from the following specification and drawings, the following of which is a brief description.

### BRIEF DESCRIPTION OF THE DRAWINGS

FIG. 1 is a schematic of the flow of an inventive system.

FIG. 2 is a schematic showing one portion of the flow of the system of FIG. 1.

FIG. 3 shows a display screen that will be displayed when a transaction is denied.

### DETAILED DESCRIPTION OF A PREFERRED EMBODIMENT

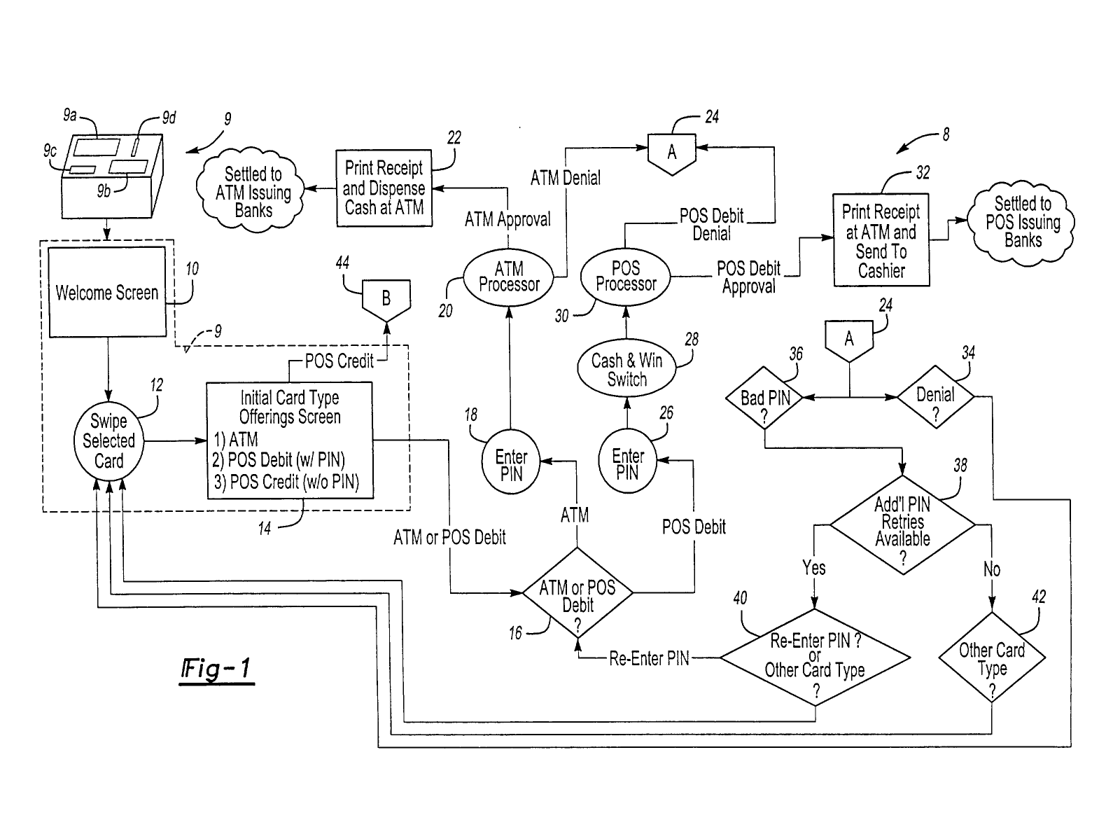

As shown in FIG. 1, an overall system 8 is provided for communicating with a single bank access machine which may be utilized in a location such as a casino. The terminal 9 includes a standard screen 9a, keyboard 9b for entry of user request information, a cash dispenser/printer 9c and a card reader 9d. This structure is shown schematically, and may all be as known. The machine has a welcome screen which will typically display information to be selected by the machine's owner, or the owner of the location where the machine is found. A portion of the welcome screen would be an instruction to swipe a card to begin a transaction. While the flow chart of this application relates to a card which is simply swiped, the invention extends as fully to the type of bank machine wherein the card is entered into a slot and held during the transaction.

Once the card is swiped, a user is offered the choice of several types of transactions.

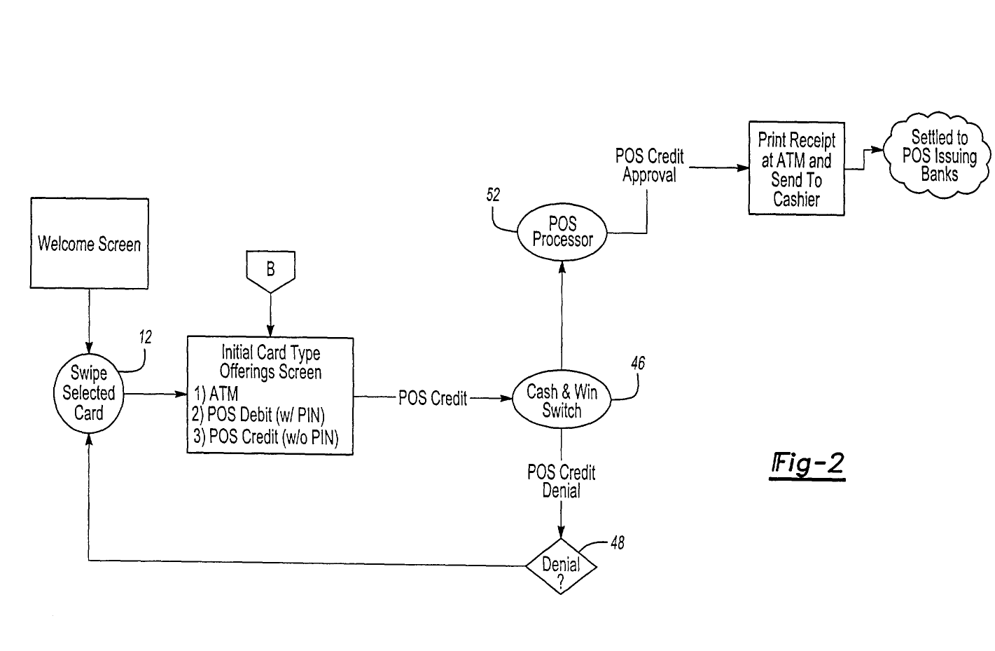

In the particular disclosed embodiment, the user may select an ATM transaction or a POS debit or credit transaction. If an ATM or POS debit type transaction is chosen, the system flows to box 16. In the event that a POS credit transaction is requested, the system flows to a box 44, which will be explained with reference to FIG. 2. At box 16, the flow continues to an ATM flow line wherein the user is requested to enter a personal identification number (“PIN”) at 18. Once the PIN is entered, the request moves toward requesting a particular amount of money. The amount of money requested along with the PIN is sent to an ATM processor 20. The ATM processor communicates with the cardholder's bank, and may approve the transaction. If the transaction is approved at 22, a receipt is printed and the system communicates with the cardholder's bank to let the cardholder's bank know that the transaction is completed. Cash is then dispensed at the machine 10.

In the event that the processor 20 receives a denial of the transaction from the issuing bank, the system flows to a box 24 which will be explained below.

Back to box 16, if a POS debit transaction is requested, then the PIN is again entered at 26. The system then moves to a switching system shown here as Cash and Win® switch. Cash and Win® is a registered trademark of the Assignee of this application, and relates to this particular type of system. From the Cash and Win® switch 28, the amount requested along with the PIN is communicated to a POS processor. Typically, the ATM processor 20 and the POS processor 30 are separate entities. If the POS debit transaction is approved, the system flows to a box 32. A receipt is printed, and a user is instructed to go to a cashier for receiving the approved cash. Optionally, a receipt may need not be printed, and the user may simply be instructed to go to a station to receive the cash. The system also communicates with the issuing bank such that a record of the withdrawal is made. The use of the POS will often allow a higher daily limit of withdrawals since the communication with the cashier station provides a higher level of security. If the POS transaction is denied, the system again flows to a box 24.

Box 24 is shown communicating back into a split of two distinct reasons for denial. If the PIN is wrong as shown at 36, the system then flows to a box 38. If additional PIN retries are available within the software, then the system flows to a box allowing the re-entry of the PIN or the selection of some other card type at 40. The re-entered PIN is communicated back to box 16, and the “other card type” simply flows back to the initial swipe selected card request of box 12. As is known, systems typically allow a particular number of PIN entries before the system will determine that the user should not be allowed to continue to re-enter PIN numbers.

If the number of retries available has been exceeded, then the system would flow to a box 42 which would request if some other card type might be desired. If so, the system again goes back to the swipe selected card screen.

In the event that the initial denial at 24 was not for a bad PIN, but for some other reason, as shown at box 34, the system flows back to the swipe selected card box 12. The denial shown in box 34 would typically be because the amount requested would exceed the balance of the users account, or the amount requested would exceed some preset limit for the particular day, etc.

It should be understood that each of the three flows leading to box 12 would be combined with the system terminating the previous transaction. That is, the flow from boxes 40, 42 or 34 back to box 12 all include the ending of the transaction by the system. A new card, or the same card, must be swiped in order to provide any further transaction.

Further, while the system is shown with a reswipe or swipe card box 12, it should also be understood that any of the flows to box 12 could occur in parallel with the card being dispensed out of the machine for the type of machine which holds onto the card during the transaction. Thus, again, with the flow as shown in FIG. 1, should any of the occurrences of the flow back to box 12 occur in a system, which is the type holding the card, the card would then be returned to the user along with appropriate instructions on the screen that the transaction has ended.

FIG. 2 shows the flow from box 44, wherein the user has requested a POS credit transaction. Again, the flow is through a Cash and Win® switch 46. If the credit is denied, the system flows to a box 48 which returns back to the swipe selected card box 12. If the transaction is approved, the POS processor 52 communicates with the issuing bank, and the system proceeds as is typical for a POS credit approval with instructions sending the user to the cashier and notification of the issuing bank.

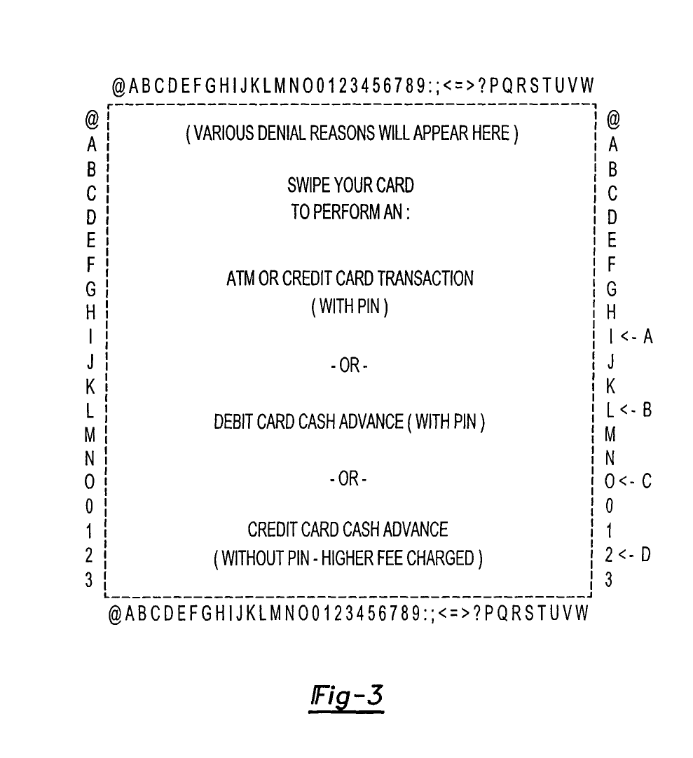

In the event that a user of an ATM or POS debit is told that the requested amount will be denied, the prior art had some deficiencies as mentioned above. In the present invention, when a denial occurs, and in particular the type denial of box 34 occurs, then a screen similar to that shown in FIG. 3 is displayed. This screen provides two pieces of information. First, the screen indicates that a denial has occurred. The screen may provide more detailed information such as why the denial occurred. Further, the screen will provide instructions to reswipe a card if the user would like any of the three types of transactions which are available in this type system. It should be understood that within the scope of this invention would be systems which only provide two potential types of transactions. It is the communication of the denial along with ending the previous transaction, and also providing indication of the denial along with an indication of available options, with all of the available options restated, which is inventive here. The prior art had deficiencies as mentioned above.

Thus, in the event of a denial such as in box 34, the screen such as shown in FIG. 3 is then displayed. A user would then be able to quickly learn that the denial has occurred, but that options do remain. It cannot be overstated how potentially distracted a user might be in an casino environment. In the prior art, which did not necessarily end the transaction, a user might simply have walked away from the screen. This then leaves the machine in the middle of a transaction, which is undesirable. Further, the user might read the denial information and believe that no options remain if the denial alone were displayed. That user might leave, even though the user might well be able to obtain cash from some other type of system, or might be able to request a lower amount and obtain it through the first type transaction.

Thus, the present invention provides valuable benefits in allowing various types of options of transactions to a user, and further in providing a more user friendly flow in the event of a denial.

These and other features of the present invention are disclosed here as examples. A worker in this art would recognize that any modifications would come within the scope of this invention, and thus the following claims should be studied to determine the true scope and content of this invention.

1. A system for providing cash to a user comprising:
a terminal including a screen for providing information to a user, a keyboard for allowing the user to enter information, and a card reader to allow a card held by the user to be read to begin a transaction;
a control being operable to receive an input indication from the user of which of a plurality of available type transactions the user would like to utilize, and then communicate with an appropriate processor based upon the requested type transaction, said control receiving information with regard to a denial of a particular requested amount, and operable upon receiving a denial for a particular requested amount to end the transaction, and provide an indication to the user that the transaction has been denied, and that the user has several options for further proceeding with a transaction.

2. A system as set forth in claim 1, wherein a single screen displays both a denial signal and also a listing of available transactions.

3. A system as set forth in claim 2, wherein the type of transaction which has just been denied is among those displayed.

4. A method of providing cash to a user comprising the steps of:
1) providing a system which is operable to receive indication of a card held by a user, and to allow a user to select any of a plurality of types of financial transactions to obtain cash, said control further being operable to communicate with issuing card banks to gain approval of a requested withdrawal;
2) communicating with an issuing card bank and receiving a denial; and
3) then ending a transaction, and providing an indication a card must be reswiped for any further transaction to occur, said indication being provided by a single screen both instructing the user that a particular transaction has been denied, and listing the users options if the user were to enter a card.

5. A method as set forth in claim 4, wherein the user's options include the type of transaction which had just been denied.
